(19) United States
(12) Patent Application Publication
(10) Pub. No.: US 2002/0038351 A1
(43) Pub. Date: Mar. 28, 2002

(54) System, method and computer program product for transcoding form content for display on thin client devices

(76) Inventors: Umair A. Khan, Fremont, CA (US); Wasiq M. Bokhari, Fremont, CA (US); Quinton Zondervan, Boston, MA (US)

Correspondence Address: SILICON VALLEY INTELLECTUAL PROPERTY GROUP, P.O. BOX 721120, SAN JOSE, CA, 95172-1120, US

(21) Appl. No.: 09/906,039

(22) Filed: Jul. 13, 2001

Related U.S. Application Data
(63) Continuation-in-part of application No. 09/595,781, filed on Jun. 16, 2000.
(60) Provisional application No. 60/283,873, filed on Apr. 12, 2001.

(51) Int. Cl. G06F 15/00

(52) U.S. Cl. 709/217; 707/513

(57) ABSTRACT

A system, method and computer program product are provided for transferring information from a network to a thin client device. Initially, a user is permitted to select components of a form in a hypertext markup language (HTML) format. Such components of the form are then sent to a thin client device. In response thereto, the content is displayed on the thin client device.

### RELATED APPLICATION(S)

This application claims the benefit of U.S. Provisional Application entitled “SYSTEM, METHOD AND COMPUTER PROGRAM PRODUCT FOR TRANSCODING FORM CONTENT FOR DISPLAY ON THIN CLIENT DEVICES”, filed provisionally under Ser. No. 60/283,873 on Apr. 12, 2001, the disclosure of which is incorporated herein by reference. The present application is also a continuation-in-part of an application entitled “SYSTEM, METHOD AND ARTICLE OF MANUFACTURE FOR WIRELESS ENABLEMENT OF THE WORLD WIDE WEB USING A WIRELESS GATEWAY,” and filed Jun. 16, 2000 under the Ser. No. 09/595,781, and which is incorporated herein by reference in its entirety. The present application further relates to an application filed concurrently herewith under the title “SYSTEM, METHOD AND COMPUTER PROGRAM PRODUCT FOR TRANSCODING TABULAR CONTENT FOR DISPLAY ON THIN CLIENT DEVICES BY WAY OF CONTENT ADDRESSING” under attorney docket number CLIC1P009, and is incorporated herein by reference in its entirety.

### FIELD OF THE INVENTION

The present invention relates to wireless devices, and more particularly to displaying network content on wireless devices.

### BACKGROUND OF THE INVENTION

The World Wide Web was initially developed at CERN, which is a particle physics laboratory based in Geneva in Switzerland. The initial work began in 1989 and centered on the development of the HyperText Transmission Protocol (HTTP), which is a network protocol for requesting and transmitting web files and documents which both web servers and browsers can understand. By December 1990, CERN had developed a web server, a text-based browser and a browser for NExTStep computers. In March 1991, the software for the text based browser was made available to a limited audience. In January 1992, an updated version of the browser (version 1.1) was made freely available on the Internet. By January 1993, there were 50 web servers in existence and freely available graphical browser software had been made available for the Apple Macintosh. By February 1993, the World Wide Web was accounting for 0.1 per cent of all Internet traffic.

One factor in the rapid acceptance and growth of the World Wide Web was the work done at the National Center for Supercomputer Applications (NCSA) at the University of Illinois in Urbana-Champaign in the USA. Their Software Development Group created a graphical web browser called Mosaic. In September 1993, they released versions of this software for Microsoft Windows running on PCs, Apple Macintoshes and Unix computers running X Windows. Each of the versions looked at and handled files in a very similar manner with images and text interspaced in the same document, allowing organizations to create visually exciting documents that could be viewed in very similar formats on the three main types of computer in use at that time.

Many members of the team who developed the original versions of Mosaic now work for Netscape Communications Corporation, a company which has developed the Netscape Web browser, which was estimated to account for around 70 per cent of all the Web browsers in use in May 1995. Following Netscape, Microsoft launched a range of Internet browsers and servers.

Since the inception of the Internet, the content available thereon has been accessed mainly by personal computers, lap tops, etc. Recently, there is a growing demand to access the large amounts of information on smaller, more mobile devices, such as personal digital assistants (PDAs), cellular phones, etc. Problems arise, however, since such thin client devices fail to have the capability of handling, i.e. receiving, storing, displaying, etc., the large amounts of information. Up to now, a burdensome engineering investment has been required for each web-site to make them “thin client enabled.”

Therefore, there is a need for an improved technique of allowing the display of network content on thin client devices.

### DISCLOSURE OF THE INVENTION

A system, method and computer program product are provided for transferring information from a network to a thin client device. Initially, a user is permitted to select components of a form in a hypertext markup language (HTML) format. Such components of the form are then sent to a thin client device. In response thereto, the components of the form are displayed on the thin client device.

In one embodiment of the present invention, the component of the form may include an input field, an actuator icon, and/or a menu. Further, the thin client device may operate in an input mode based on the receipt of the components of the form. In such input mode, a user of the thin client device may be prompted to input data. Further, such data may be used to retrieve content for display on thin client devices.

### BRIEF DESCRIPTION OF THE DRAWINGS

FIG. 1 is a schematic diagram of a hardware implementation of an embodiment of the present invention;

FIG. 1A illustrates a method for transferring information from a network to a thin client device;

FIG. 2 illustrates the manner in which the data is transformed into different formats while be transferred from a network environment to a thin client device;

FIG. 2A illustrates an exemplary display of a form information screen in accordance with an embodiment of the present invention;

FIG. 2B illustrates an exemplary display of a form information screen transformed to XML in accordance with an embodiment of the present invention;

FIG. 3 illustrates an exemplary table that is generated in response to user input from the form information screen of FIG. 2B;

FIG. 4 is an illustration of an HTML page including weather information in accordance with another preferred embodiment;

FIG. 6 illustrates an exemplary submitting form in accordance with an embodiment of the present invention; and

FIG. 7 illustrates an exemplary thin client device display in accordance with an embodiment of the present invention.

### DESCRIPTION OF THE PREFERRED EMBODIMENTS

Exemplary Architecture

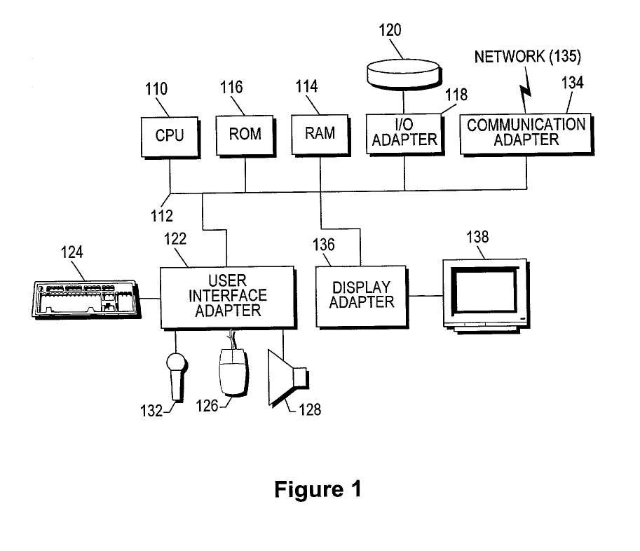

FIG. 1 shows a representative hardware environment on which the present invention may be implemented. Such figure illustrates a typical hardware configuration of a workstation in accordance with a preferred embodiment having a central processing unit 110, such as a microprocessor, and a number of other units interconnected via a system bus 112.

The workstation shown in FIG. 1 includes a Random Access Memory (RAM) 114, Read Only Memory (ROM) 116, an I/O adapter 118 for connecting peripheral devices such as disk storage units 120 to the bus 112, a user interface adapter 122 for connecting a keyboard 124, a mouse 126, a speaker 128, a microphone 132, and/or other user interface devices such as a touch screen (not shown) to the bus 112, communication adapter 134 for connecting the workstation to a communication network 135 (e.g., a data processing network) and a display adapter 136 for connecting the bus 112 to a display device 138.

The workstation typically has resident thereon an operating system such as the Microsoft Windows NT or Windows/95 Operating System (OS), the IBM OS/2 operating system, the MAC OS, or UNIX operating system. Those skilled in the art may appreciate that the present invention may also be implemented on platforms and operating systems other than those mentioned.

Such workstation may be networked to a plurality of thin client devices utilizing a wireless network. Further, the workstation may be connected to other sources of information via the Internet. Further information regarding thin client devices will now be set forth.

In one embodiment, the thin client devices may be wireless devices. In such embodiment, the host computer system may include a peripheral interface adapter that provides for the bi-directional transfer of the data via an interconnect line to a transceiver that supports wireless communications with one or more wireless devices. The transceiver, in a simple embodiment, implements a low-power 900 Mhz or 2.4 Ghz transceiver for short-range communication with the wireless devices. In another embodiment, however, the transceiver may be part of a cellular or digital telephone network that allows communication between the host computer and the wireless devices at great distances, including geographically remote locations. It should be noted that, in other embodiments, any type of wireless system may be employed to afford wireless communication.

In various alternate embodiments, the display panel may be an active matrix liquid crystal display (LCD), or dual-scan super-twist pneumatic display suitable for rendering color images at a resolution of about 640×480 pixels or greater. Low cost display panels with reduced resolutions and only monochrome display capabilities can also be utilized. In all events, the display panel is preferably lightweight, reasonably sturdy, and suitable for the graphic display of at least computer video data.

As an option, an unillustrated mini keyboard may be provided of any number of conventional configurations. Such keyboard may be used to provide for alphanumeric keyed data entry in a relatively small two-dimensional form factor. Ultimately, the mini keyboard may be replaced with a smaller number of programmable function keys that programmatically adapt as appropriate to the function of any current application displayed by the display panel. The mini keyboard may be entirely replaced with a virtual keyboard implemented by the display panel in connection with a touch screen sensor mounted in the case of the wireless device. Thus full function and specialized function data entry keys can be created as necessary or desired in support of the use of any application displayed by the display panel.

As yet another option, a pointing device, such as a power point tracking device or track ball can be provided to allow the wireless device to be easily held while the pointing device is manipulated. Similarly, pointer buttons are preferably configured in close proximity to the pointing device to again allow easy access and use while the wireless device is held. Preferably, pointer buttons may be programmable in defining the function performed or recognized in response to each press of the buttons.

In another embodiment of the present invention, an audio pick-up transducer and pair of speakers may be included in support of multimedia utilization of the wireless device.

To enable wireless communication, a transceiver antenna may be mounted within the case. Although the display panel and other electronics located within the case may be electromagnetically shielded, the cross section of such shielding should not significantly affect the efficiency of the antenna. Where the shielding presents a problem or the display table is operated near noise sources or at the near limit of the service area, the antenna may be constructed to permit external extension.

The flexibility and functionality of the wireless device may be augmented by the addition of a PCMCIA peripheral card. As conventional PCMCIA cards are removable, the function or functions that can be added to the wireless device depends on the implementation of the PCMCIA card itself. A PCMCIA card may implement a cellular phone interface would allow the wireless device to be operated at great distance from the host computer through a combination of air-links and land-lines that route to the host computer system in a conventional manner. The PCMCIA card may also implement an analog or digital modem or other high-speed serial or parallel interface that can connect either directly to the host computer when the wireless device is conveniently close to the host computer or remotely through any combination of air-links and land-lines. The PCMCIA card may also implement supplementary functions to augment the multimedia capabilities of the wireless device, other communications protocols and data connection systems, and upgrades to the basic capabilities present in the wireless device, including new encoding, encryption and compression capabilities.

A connector can provide external power access that provides operating power and, potentially, power for recharging batteries provided within the case of the wireless device. Other connectors may provide for conventional keyboard, mouse and joysticks, as external peripherals, to be fully integratable into the overall function of the display table.

While the use of small high energy density rechargeable batteries is preferred, the power consumption requirements of the wireless device can be managed closely to minimize the power load that is required to be supported in the normal operation of the wireless device. The refresh frequency and brightness of the display panel may be reduced during periods of perceived inactivity. The transmission power produced by the on board transceiver connected to the antenna may be selectively reduced to meet a minimum acceptable noise margin. This may have the additional benefit of reducing the effective size of the service area to an area specifically appropriate to the unique location of a particular wireless device, thereby reducing the possibility of signal interception and unnecessary cross-talk. Finally, subsystems such as the PCMCIA card and multimedia support circuitry providing signal and power to the speakers and transducer can be selectively powered down when their use is not needed or desired. As a result, the wireless device should have a battery life of from two to four hours.

The internal electronic control system of the wireless device is preferably constructed as a low-cost embedded microprocessor control system utilizing a main processor bus to provide a data and control interconnect between a microcontroller CPU and a main memory bank. The microcontroller can be directly implemented utilizing any of a wide number of a existing low-power, high-performance microcontrollers, such as the Intel 80C51 series, the Intel 80C196KB high performance CHMOS microcontroller, or the like.

The main memory is preferably constructed utilizing approximately two to ten megabytes of low-power dynamic RAM memory. While the wireless device will support the execution of almost any number of complex applications, the resident main memory need not be of significant size. The application programs are executed on the host computer while, in the preferred embodiment, the operation of the wireless device is strictly limited to the terminal display of graphic and related data. Thus, the main memory is preferably sized sufficient to allow execution of a control program implementing primarily the display function of the tablet independent of the actual execution of the application program. Consequently, not only is the size of the main memory both reduced and largely non-critical in relationship to the complexity and type of application programs executed by the host computer, but the microcontroller is not constrained by compatibility issues with regard to the type of CPU utilized by the host computer or the specific type and version of the operating system executed.

Some combination of non-volatile RAM and ROM memory may be provided to store at least a portion of the control program that is executed by the microcontroller. The non-volatile RAM/ROM memory preferably stores at least a portion of the control program sufficient to enable the microcontroller to download the remaining portions or full new image of a control program from the host computer. To permit future upgrades of event the permanently resident portion of the control program, non-volatile RAM memory can be utilized to allow field upgradability.

A conventional power controller may provide the regulation of power to the control system from either an external power source or the onboard battery. The power controller preferably is programmable by the microcontroller to selectively provide power to separate subsystems of the controller. The microcontroller is therefore able to effectively manage power consumption by the control system as a whole. Specifically, independent power regulation may be provided for an audio subsystem, PCMCIA interface and a short-range transceiver. Power may be regulated selectively for other components of the control system where continued or excessive power consumption is unnecessary or undesirable.

A generally conventional video graphics controller may be provided as the control interface for managing the operation of the display panel. The video graphics controller may internally implement a simple hardware graphics adaptor or more complex hardware graphics accelerator for enhancing the effective speed of the video graphics controller and, in general, the perceptible performance of the wireless device.

Depending on the resolution supported by the video graphics controller, including color depth, a conventional video memory array may be provided as frame and scratch pad memory for use by the video graphics controller. Generally, a minimum of 1 megabyte of video memory is sufficient to support a display panel resolution of 640×480 at a color depth of 8 bits. The video memory may be expandable to two, four or more megabytes of memory as appropriate to support the function of video graphics controller.

A conventional LCD driver circuit may also be connected to the video graphics controller to generate the control and driver signals necessary to directly operate the display panel.

Finally, a touch screen interface may be provided to support a touch screen function in connection with the display panel. The video graphics controller may include circuitry for operating and responding to the touch screen interface as needed to digitally represent a screen touch. This information is then available for use by the microcontroller in much the same manner as any other pointing device information is made available by the microcontroller.

The audio subsystem may include the conventional functionality of multimedia peripheral cards for personal computers. The preferred supported functions include digital-to-analog conversion and power amplification of stereo audio channels as appropriate to drive the speakers. The audio subsystem preferably also includes an analog-to-digital converter connected to the transducer. Additional analog or digital signal processing circuitry may be provided to reduce noise and eliminate feedback from the speakers prior to or after the analog-to-digital conversion is performed by the audio subsystem.

Finally, a PCMCIA interface may provide a 16-bit wide, high-speed parallel interface between the connector or connectors supported by the PCMCIA slot and the main processor bus. The PCMCIA interface itself is preferably implemented through the use of a conventional PCMCIA interface controller chip.

Any number of applications can be executed concurrently by the host computer in accordance with the normal operation of the operating system or, as in the preferred embodiment, subject to an effective partitioning of the operating system execution states to support concurrent execution of the multiple applications by an otherwise single-user operating system. In both events, the applications present calls to the operating system including, in particular, calls relating to the display and update of images on a respective display. These displays, however, are logical displays that are mapped by the operating system into a single master logical display space utilizing, as appropriate, windowing and desktop paradigms for the presentation of the composite master logical display. That is, the master logical display is drawn by the operating system by a series of appropriate low-level display driver calls to a display driver.

In the preferred embodiments of the present invention, a pseudo-display driver may be provided to manage the detailed presentation of a master logical display within a window of another master logical display corresponding to another partition of the execution environment supported by the operating system. The pseudo-display driver effectively operates to intercept low-level display driver calls from any or all of the operating system execution partitions. The output of an executing partition may be directed to an independent display, such as the local video display or passed substantially unaltered to a long-range transceiver driver. In an initial implementation of the present invention, the long-range transceiver driver and the low-power transceiver is instantiated once for each wireless device supported by the host computer system. Thus, the display driver calls from a single executing partition of the operating system, or multiple partitions operating in collaboration, are passed as a driver call stream to the long-range transceiver driver for transmission to a corresponding wireless device. Outbound audio data and inbound pointer and audio data are processed through the long-range transceiver driver. Outbound audio data and inbound input and audio data may be transferred directly between the operating system and long-range transceiver driver subject to maintaining the correlation between the applications executing within the execution partition of the operating system associated with the particular instantiation of the long-range transceiver driver corresponding to that partition. Consequently, a proper association both for inbound and outbound data for specific applications is maintained through the operating system as between the host computer system and any number of wireless devices.

A preferred alternate embodiment of the present invention preferably provides for a single long-range transceiver driver that is effectively aware, as is the pseudo-display driver, of the multiple partition execution space of the operating system. This alternate long-range transceiver driver preferably supports a multi-channel spread spectrum transceiver. Display and analog output data associated with execution partitions of the operating system respectively directed for transmission to a particular wireless device to implement the low-level display driver. Consequently, the appropriate physical display, either the local video display or a wireless device is updated consistent with the ongoing execution of the corresponding operating system partition. The long-range transceiver driver may further provide for variable encryption and decryption of the low-level driver call data streams that pass through the driver. Destination signatures may also be included into the data streams to specifically identify the particular recipient host computer and wireless device that are intended to be exclusively communicating over a particular channel supported by the transceiver. This provides both security over an appropriate interception of the transmitted data as well as secure validation that data streams are being sourced and received by the intended participants.

Nominally, the client application itself is charged with the responsibility to decode, decrypt or decompress data for presentation. Various graphical images transmitted to browser applications are encoded and/or compressed using various lossee or lossless algorithms to substantially reduce the transmitted data size. In a relationship to this class of application, one embodiment of the present invention implements a processed data bypass that allows the encoded, encrypted or compressed data as received by the host computer to be transferred in an unaltered form to a wireless device. Since data transferred in an encoded, encrypted or compressed form is done subject to a public algorithm specification, no compatibility issues arise by allowing the microcontroller with implementing the unencoding, decrypting or decompression algorithm yet maximizing the effective utilization of the bandwidth connection between the wireless device and host computer system.

A complication arises particularly in Web browser applications. There, the rendered display is content dependent. Therefore, display dependencies are resolved dynamically by the application based on the final representation of any unencoded, decrypted and decompressed data. In such circumstances, the host computer system must provide for fall processing of the received data in support of the otherwise ordinary operation of the application as needed to produce a finally determined impression of the information to be displayed by a wireless device. This is handled in the present invention on the host computer side through the further implementation of the host system detail. A socket driver, conventionally referred to as a WinSock driver in relationship to Microsoft operating systems, manages a network socket connection to a remote computer system that is the source of encoded, encrypted or compressed data. The WinSock driver effectively supports bi-directional data transfer between the driver and operating system in support of the pseudo-display driver and an exemplary Web browser application. The WinSock driver is typically merged with the operating system to extend the application program interface (API) that is presented to the browser application.

The WinSock driver is preferably modified to identify objects such as compressed data images from the inbound socket data stream. The object is identified by the driver not only as being subject to immediate bypass to the long-range transceiver driver, but further that the socket data stream carrying the object is destined for a particular application. Thus, the long-range transceiver driver is provided with both the bypassed data object and at least an identification of the particular wireless device that is to receive the object. The data object as passed to the long-range transceiver driver and, in parallel, to the operating system with a unique identification tag generated by the WinSock driver. This tag is associated with the data object in the socket data stream ultimately for use by the pseudo-display driver. Preferably, the data object tag and the communication of the tag to the pseudo-display driver is provided logically separate from the socket data stream that is provided through the operating system to the browser application. Consequently, an entirely conventional browser application may be utilized in connection with the present invention without loss of performance or compatibility. Data objects received by the browser application are therefore conventionally unencoded, decrypted, and decompressed and used if and as necessary to resolve dependencies on, for example, the size and location of a graphic image in relationship to text within the browser applications current logical display. That is, the browser application processes the received socket data stream and produces a series of operating system calls to define the appearance of the logical display window controlled by the browser application.

Operating system display calls are further reduced by the operating system to low-level display driver calls that are passed to the pseudo display driver. Based on an examination of the various data objects identified to the pseudo-display driver in connection with the low-level display driver calls, respective unique identifying data object tags are identified by the pseudo-display drive. Each tag, as identified, is used to replace the unencoded, decrypted or decompressed representation of the corresponding data object. Thus, only display driver calls referencing data object tags and untagged data are processed through the pseudo-display driver to the long-range transceiver driver for transmission to a wireless device.

In the preferred embodiment of the present invention, the long-range transceiver driver operates to transmit fixed block size data packets that together convey messages to a wireless device. A message can be a data object received from the WinSock driver. Other messages include a low-level device driver call and as appropriate for the call, a display object tag or an untagged data object as received from the pseudo display driver. A tagged data object identified and provided from the WinSock driver will therefore be at least queued for transmission to a corresponding wireless device prior to a display object tag being provided by the pseudo display driver to the long-range transceiver driver for transmission to the same wireless device. Furthermore, the latency between the transmission of the data object itself and transmission of the tag allows a quite adequate amount of time for the microcontroller to receive and, as appropriate, process the data object into an unencoded, decrypted or decompressed form. The actual latency incurred at different times will be determined by operating system and browser application, executed and latencies that control the generation of display driver calls by the operating system to the pseudo display driver to pass a data object tag to the long-range transceiver driver.

Software Framework

A preferred embodiment is written using JAVA, C, and the C++ language and utilizes object oriented programming methodology. Object oriented programming (OOP) has become increasingly used to develop complex applications. As OOP moves toward the mainstream of software design and development, various software solutions require adaptation to make use of the benefits of OOP. A need exists for these principles of OOP to be applied to a messaging interface of an electronic messaging system such that a set of OOP classes and objects for the messaging interface can be provided.

OOP is a process of developing computer software using objects, including the steps of analyzing the problem, designing the system, and constructing the program. An object is a software package that contains both data and a collection of related structures and procedures. Since it contains both data and a collection of structures and procedures, it can be visualized as a self-sufficient component that does not require other additional structures, procedures or data to perform its specific task. OOP, therefore, views a computer program as a collection of largely autonomous components, called objects, each of which is responsible for a specific task. This concept of packaging data, structures, and procedures together in one component or module is called encapsulation.

In general, OOP components are reusable software modules which present an interface that conforms to an object model and which are accessed at run-time through a component integration architecture. A component integration architecture is a set of architecture mechanisms which allow software modules in different process spaces to utilize each others capabilities or fictions. This is generally done by assuming a common component object model on which to build the architecture. It is worthwhile to differentiate between an object and a class of objects at this point. An object is a single instance of the class of objects, which is often just called a class. A class of objects can be viewed as a blueprint, from which many objects can be formed.

OOP allows the programmer to create an object that is a part of another object. For example, the object representing a piston engine is said to have a composition-relationship with the object representing a piston. In reality, a piston engine comprises a piston, valves and many other components; the fact that a piston is an element of a piston engine can be logically and semantically represented in OOP by two objects.

OOP also allows creation of an object that “depends from” another object. If there are two objects, one representing a piston engine and the other representing a piston engine wherein the piston is made of ceramic, then the relationship between the two objects is not that of composition. A ceramic piston engine does not make up a piston engine. Rather it is merely one kind of piston engine that has one more limitation than the piston engine; its piston is made of ceramic. In this case, the object representing the ceramic piston engine is called a derived object, and it inherits all of the aspects of the object representing the piston engine and adds further limitation or detail to it. The object representing the ceramic piston engine “depends from” the object representing the piston engine. The relationship between these objects is called inheritance. When the object or class representing the ceramic piston engine inherits all of the aspects of the objects representing the piston engine, it inherits the thermal characteristics of a standard piston defined in the piston engine class. However, the ceramic piston engine object overrides these ceramic specific thermal characteristics, which are typically different from those associated with a metal piston. It skips over the original and uses new functions related to ceramic pistons. Different kinds of piston engines have different characteristics, but may have the same underlying functions associated with it (e.g., how many pistons in the engine, ignition sequences, lubrication, etc.). To access each of these functions in any piston engine object, a programmer would call the same fictions with the same names, but each type of piston engine may have different/overriding implementations of functions behind the same name. This ability to hide different implementations of a function behind the same name is called polymorphism and it greatly simplifies communication among objects.

With the concepts of composition-relationship, encapsulation, inheritance and polymorphism, an object can represent just about anything in the real world. In fact, one's logical perception of the reality is the only limit on determining the kinds of things that can become objects in object-oriented software. Some typical categories are as follows:

Objects can represent physical objects, such as automobiles in a traffic-flow simulation, electrical components in a circuit-design program, countries in an economics model, or aircraft in an air-traffic-control system.

Objects can represent elements of the computer-user environment such as windows, menus or graphics objects.

An object can represent an inventory, such as a personnel file or a table of the latitudes and longitudes of cities.

An object can represent user-defined data types such as time, angles, and complex numbers, or points on the plane.

With this enormous capability of an object to represent just about any logically separable matters, OOP allows the software developer to design and implement a computer program that is a model of some aspects of reality, whether that reality is a physical entity, a process, a system, or a composition of matter. Since the object can represent anything, the software developer can create an object which can be used as a component in a larger software project in the future.

If 90% of a new OOP software program consists of proven, existing components made from preexisting reusable objects, then only the remaining 10% of the new software project has to be written and tested from scratch. Since 90% already came from an inventory of extensively tested reusable objects, the potential domain from which an error could originate is 10% of the program. As a result, OOP enables software developers to build objects out of other, previously built objects.

This process closely resembles complex machinery being built out of assemblies and sub-assemblies. OOP technology, therefore, makes software engineering more like hardware engineering in that software is built from existing components, which are available to the developer as objects. All this adds up to an improved quality of the software as well as an increased speed of its development.

Programming languages are beginning to filly support the OOP principles, such as encapsulation, inheritance, polymorphism, and composition-relationship. With the advent of the C++ language, many commercial software developers have embraced OOP. C++ is an OOP language that offers a fast, machine-executable code. Furthermore, C++ is suitable for both commercial-application and systems-programming projects. For now, C++ appears to be the most popular choice among many OOP programmers, but there is a host of other OOP languages, such as Smalltalk, Common Lisp Object System (CLOS), and Eiffel. Additionally, OOP capabilities are being added to more traditional popular computer programming languages such as Pascal.

The benefits of object classes can be summarized, as follows:

Objects and their corresponding classes break down complex programming problems into many smaller, simpler problems.

Encapsulation enforces data abstraction through the organization of data into small, independent objects that can communicate with each other.

Encapsulation protects the data in an object from accidental damage, but allows other objects to interact with that data by calling the object's member functions and structures.

Subclassing and inheritance make it possible to extend and modify objects through deriving new kinds of objects from the standard classes available in the system. Thus, new capabilities are created without having to start from scratch.

Polymorphism and multiple inheritance make it possible for different programmers to mix and match characteristics of many different classes and create specialized objects that can still work with related objects in predictable ways.

Class hierarchies and containment hierarchies provide a flexible mechanism for modeling real-world objects and the relationships among them.

Libraries of reusable classes are useful in many situations, but they also have some limitations. For example:

Complexity. In a complex system, the class hierarchies for related classes can become extremely confusing, with many dozens or even hundreds of classes.

Flow of control. A program written with the aid of class libraries is still responsible for the flow of control (i.e., it may control the interactions among all the objects created from a particular library). The programmer has to decide which functions to call at what times for which kinds of objects.

Duplication of effort. Although class libraries allow programmers to use and reuse many small pieces of code, each programmer puts those pieces together in a different way. Two different programmers can use the same set of class libraries to write two programs that do exactly the same thing but whose internal structure (i.e., design) may be quite different, depending on hundreds of small decisions each programmer makes along the way. Inevitably, similar pieces of code end up doing similar things in slightly different ways and do not work as well together as they should.

Class libraries are very flexible. As programs grow more complex, more programmers are forced to reinvent basic solutions to basic problems over and over again. A relatively new extension of the class library concept is to have a framework of class libraries. This framework is more complex and consists of significant collections of collaborating classes that capture both the small scale patterns and major mechanisms that implement the common requirements and design in a specific application domain. They were first developed to free application programmers from the chores involved in displaying menus, windows, dialog boxes, and other standard user interface elements for personal computers.

Frameworks also represent a change in the way programmers think about the interaction between the code they write and code written by others. In the early days of procedural programming, the programmer called libraries provided by the operating system to perform certain tasks, but basically the program executed down the page from start to finish, and the programmer was solely responsible for the flow of control. This was appropriate for printing out paychecks, calculating a mathematical table, or solving other problems with a program that executed in just one way.

The development of graphical user interfaces began to turn this procedural programming arrangement inside out. These interfaces allow the user, rather than program logic, to drive the program and decide when certain actions should be performed. Today, most personal computer software accomplishes this by means of an event loop which monitors the mouse, keyboard, and other sources of external events and calls the appropriate parts of the programmer's code according to actions that the user performs. The programmer no longer determines the order in which events occur. Instead, a program is divided into separate pieces that are called at unpredictable times and in an unpredictable order. By relinquishing control in this way to users, the developer creates a program that is much easier to use. Nevertheless, individual pieces of the program written by the developer still call libraries provided by the operating system to accomplish certain tasks, and the programmer may still determine the flow of control within each piece after it's called by the event loop. Application code still “sits on top of” the system.

Even event loop programs require programmers to write a lot of code that should not need to be written separately for every application. The concept of an application framework carries the event loop concept further. Instead of dealing with all the nuts and bolts of constructing basic menus, windows, and dialog boxes and then making these things all work together, programmers using application frameworks start with working application code and basic user interface elements in place. Subsequently, they build from there by replacing some of the generic capabilities of the framework with the specific capabilities of the intended application.

Application frameworks reduce the total amount of code that a programmer has to write from scratch. However, because the framework is really a generic application that displays windows, supports copy and paste, and so on, the programmer can also relinquish control to a greater degree than event loop programs permit. The framework code takes care of almost all event handling and flow of control, and the programmer's code is called only when the framework needs it (e.g., to create or manipulate a proprietary data structure).

A programmer writing a framework program not only relinquishes control to the user (as is also true for event loop programs), but also relinquishes the detailed flow of control within the program to the framework. This approach allows the creation of more complex systems that work together in interesting ways, as opposed to isolated programs, having custom code, being created over and over again for similar problems.

Thus, as is explained above, a framework basically is a collection of cooperating classes that make up a reusable design solution for a given problem domain. It typically includes objects that provide default behavior (e.g., for menus and windows), and programmers use it by inheriting some of that default behavior and overriding other behavior so that the framework calls application code at the appropriate times.

There are three main differences between frameworks and class libraries:

Behavior versus protocol. Class libraries are essentially collections of behaviors that one can call when he or she want those individual behaviors in a program.

A framework, on the other hand, provides not only behavior but also the protocol or set of rules that govern the ways in which behaviors can be combined, including rules for what a programmer is supposed to provide versus what the framework provides.

Call versus override. With a class library, the code the programmer instantiates objects and calls their member functions. It's possible to instantiate and call objects in the same way with a framework (i.e., to treat the framework as a class library), but to take full advantage of a framework's reusable design, a programmer typically writes code that overrides and is called by the framework. The framework manages the flow of control among its objects. Writing a program involves dividing responsibilities among the various pieces of software that are called by the framework rather than specifying how the different pieces should work together.

Implementation versus design. With class libraries, programmers reuse only implementations, whereas with frameworks, they reuse design. A framework embodies the way a family of related programs or pieces of software work. It represents a generic design solution that can be adapted to a variety of specific problems in a given domain. For example, a single framework can embody the way a user interface works, even though two different user interfaces created with the same framework might solve quite different interface problems.

Thus, through the development of frameworks for solutions to various problems and programming tasks, significant reductions in the design and development effort for software can be achieved. A preferred embodiment of the invention utilizes HyperText Markup Language (HTML) to implement documents on the Internet together with a general-purpose secure communication protocol for a transport medium between the client and the Newco. HTTP or other protocols could be readily substituted for HTML without undue experimentation. Information on these products is available in T. Bemers-Lee, D. Connoly, “RFC 1866: Hypertext Markup Language −2.0” (Nov. 1995); and R. Fielding, H, Frystyk, T. Bemers-Lee, J. Gettys and J. C. Mogul, “Hypertext Transfer Protocol—HTTP/1.1: HTTP Working Group Internet Draft” (May 2, 1996). HTML is a simple data format used to create hypertext documents that are portable from one platform to another. HTML documents are SGML documents with generic semantics that are appropriate for representing information from a wide range of domains. HTML has been in use by the World-Wide Web global information initiative since 1990. HTML is an application of ISO Standard 8879; 1986 Information Processing Text and Office Systems; Standard Generalized Markup Language (SGML).

To date, Web development tools have been limited in their ability to create dynamic Web applications which span from client to server and interoperate with existing computing resources. Until recently, HTML has been the dominant technology used in development of Web-based solutions. However, HTML has proven to be inadequate in the following areas:

Poor performance;

Restricted user interface capabilities;

Can only produce static Web pages;

Lack of interoperability with existing applications and data; and

Inability to scale.

Sun Microsystem's Java language solves many of the client-side problems by:

Improving performance on the client side;

Enabling the creation of dynamic, real-time Web applications; and

Providing the ability to create a wide variety of user interface components.

With Java, developers can create robust User Interface (UI) components. Custom “widgets” (e.g., real-time stock tickers, animated icons, etc.) can be created, and client-side performance is improved. Unlike HTML, Java supports the notion of client-side validation, offloading appropriate processing onto the client for improved performance. Dynamic, real-time Web pages can be created. Using the above-mentioned custom UI components, dynamic Web pages can also be created.

Sun's Java language has emerged as an industry-recognized language for “programming the Internet.” Sun defines Java as: “a simple, object-oriented, distributed, interpreted, robust, secure, architecture-neutral, portable, high-performance, multithreaded, dynamic, buzzword-compliant, general-purpose programming language. Java supports programming for the Internet in the form of platform-independent Java applets.” Java applets are small, specialized applications that comply with Sun's Java Application Programming Interface (API) allowing developers to add “interactive content” to Web documents (e.g., simple animations, page adornments, basic games, etc.). Applets execute within a Java-compatible browser (e.g., Netscape Navigator) by copying code from the server to client. From a language standpoint, Java's core feature set is based on C++. Sun's Java literature states that Java is basically, “C++ with extensions from Objective C for more dynamic method resolution.”

Another technology that provides similar function to JAVA is provided by Microsoft and ActiveX Technologies, to give developers and Web designers wherewithal to build dynamic content for the Internet and personal computers. ActiveX includes tools for developing animation, 3-D virtual reality, video and other multimedia content. The tools use Internet standards, work on multiple platforms, and are being supported by over 100 companies. The group's building blocks are called ActiveX Controls, small, fast components that enable developers to embed parts of software in hypertext markup language (HTML) pages. ActiveX Controls work with a variety of programming languages including Microsoft Visual C++, Borland Delphi, Microsoft Visual Basic programming system and, in the future, Microsoft's development tool for Java, code named “Jakarta.” ActiveX Technologies also includes ActiveX Server Framework, allowing developers to create server applications. One of ordinary skill in the art readily recognizes that ActiveX could be substituted for JAVA without undue experimentation to practice the invention.

Exemplary Environment

One embodiment of the present invention may allow a user to create an information portal whose source and content is completely customizable. Information on the web exists in the form of hyperlinks that appear in different web-sites. A news site, for example, may contain headlines that are hyperlinks to their detailed exposition. In typical portals, the user chooses from a pre-determined set of headlines collected from a pre-determined set of web-sites. The user has no control over either the web-sites she gets the content from or the headlines that are taken from those web-sites. The present embodiment allows the user to completely configure both the source and content that she wants on her own portal.

The user is presented with a page that contains user's information of choice from an arbitrary number of different sources and presented in completely customizable format. The page consists of different “views” where each view in turn contains multiple windows. The number of views and the number of windows in each view can be configured. Each particular window contains hyperlinks that have been selected by the user from web-sites of her choice.

A window may, for instance, be dedicated for international news and could contain hyperlinks selected by the user from any number of web-sites of her choice. The user has complete freedom in selecting the source of her content (i.e. the web-site) and the content from that source (i.e. the hyperlinks).

When the user wishes to add content, she is presented with the web-page that she chooses. The user then selects the headline or hyperlink of her choice, and simply drags and drops it into her portal. From that point on, the content from that headline or hyperlink is brought to the user's portal regularly. If the content changes or is refreshed, the new content is brought to the user. The user may edit the information content of her portal at will by adding or deleting headlines, moving them from one window to another within a view or moving them to other windows in different views.

The invention consists of the following parts: (a) an interface that displays the user customized information, (b) an interface that allows the user to select and manage the information of choice, (c) a mechanism for marking selected information contained in a web-page, (d) a mechanism for the storage of the selected information, (e) a method for communicating that information to the backend servers that process and store that information, (f) a mechanism for regularly retrieving selected information, and (g) a mechanism for checking for change in the content or the format of the selected sources of information. Details of the foregoing components will now be set forth.

### An Interface that Displays the User Customized Information

The user interface consists of “views”, each of which include multiple windows. The number of windows in a view is completely configurable. The user may create or delete as many views as she may desire. This user interface allows a user to cleanly categorize related information within individual windows and views. This provides a user one place to access all of her favorite information and content from the web.

This may include content include, but is not limited to: (a) News and Information headlines (of all sorts) (b) Information about email, bank and other accounts (c) Information about shopping and comparison of rates and prices (d) Graphs, Images, Sounds or any other media. This content is presented to the user with an ability to edit and manage it intuitively and interactively. Some of the features of the management process include (a) a presentation of the user's selected information over a configurable number of days in the past (b) an ability to select, maximize, minimize, refresh or edit the content of individual windows (c) to “publish” user's views into a directory of views and (d) to share these views with other people by emailing them the views.

### An Interface that Allows the User to Select and Manage the Information of Choice

The interface that allows the user to create her customized portal is based on an intuitive drag and drop capability. The user simply selects the sources or headlines of choice and drags and drops them into windows and views of choice. The drag and drop feature also makes customization very easy for the user, allowing quick compilation and management of their preferred content. There are two levels of selection and management provided, (1) default and (2) advanced.

Default Mode

In the default mode, a user is presented with a set of web-sites or other sources of content. The user selects a site and then drags and drops it into a window of choice. Once that is done, pre-selected content from that source is automatically added to the window.

Advanced Mode

In the advanced mode, a user selects a web-site from a list or specifies its URL. A new window appears that shows the selected web-site. The user then chooses content of choice from the web-site and drags and drops it into a window of choice.

### A Mechanism for Marking Selected Information Contained in a Web-page

Web-pages are created using HTML (Hyper Text Markup Language). The content in a web-page may be formatted using a tabular format where each table is composed of individual cells distributed into a number of rows and columns.

The content in a web-page is formatted using a tabular format where each table is composed of individual cells distributed into a number of rows and columnns. A table may contain other tables within its individual cells. The tagging of selected information within a web-page hinges upon assigning an address to each item of content within the web-page.

An address in accordance with the present invention may take into account the table(s), row(s), column(s) and cell(s) to which an item of content belongs. As such, an item of content can be identified by its address within a web-page and all the addressing schemes that take into account the table(s), row(s), column(s) and cell(s) to which an item of content belongs. The addressing scheme will now be set forth.

The page is viewed to be composed of tables that may themselves contain other tables. The tables that are not contained in any other table (highest-level tables) are assigned identifying numbers starting from one (1). Tables contained within the highest-level tables are assigned numbers that take into account the tables that contain them. If a table is not contained in any other table, then it may be assigned a number, say three (3). If table number 3 contains two tables, then they will be assigned numbers 3-1 and 3-2 respectively.

Each table may thus be composed of a unique number of rows and columns. Each item of content resides within a cell that belongs to a specific row and column of a table. The complete address of an item of content is then the unique identifier of the table that contains it and the position of that item of content within that table.

Once the address of selected content is determined, it may be converted into a hyperlink that contains the original content or a hyperlink to it, and its address. When a user drags and drops that selected content into a window of choice, that hyperlink and all of its associated information is sent through the window to the servers where it is entered into a database.

This mechanism also allows a capture of configurable sections of a web-page including individual words, lines, paragraphs.

In the case of secure information like email or bank accounts, the mechanism is modified. First, forms are created to allow a user to log into their accounts. These forms consist of (a) dynamic information (like the user name and password) which is captured during the session (b) static information that is required by the remote account server which is stored in a database and retrieved when an account is selected. Using the dynamic and static information, the server logs into the remote server. The account information is then retrieved, and presented in a suitable and configurable format. More information regarding such forms will be set forth during reference to FIG. 1A.

### A Mechanism for the Storage of the Selected Information

The selected information is cached or stored locally to enable a faster access. Once a web-site is selected by a user, a copy of the site, including text and images, is kept locally in the servers. When any user requests a page that has been requested before, the cached copy is presented if the content of the site has not changed since the time the page was cached. The process is broken down into two components: (1) simple addition of content; and (2) customized addition of content:

Addition of Default Content

The manner with which the addition of default content proceeds will now be set forth. Once a site is selected, the backend server identifies the headlines that have been pre-selected for that site. The server queries the database and picks up the default headlines. The headlines that are not included in the pre-selected content are not included. The server contacts the ActiveX control that constitutes the administrative page and communicates the selected headlines. The selected headlines are visible in the ActiveX control and are also accessible to the main user interface.

Addition of Customized Content

In the case of addition of customized content, the process begins by the user selecting a hyperlink by dragging and dropping them into the ActiveX control on the administrative page.

The hyperlink and related information are then sent to the servers. The information includes (a) the content of the link, (b) its location on the page, (c) the URL of the site, (d) the identity of the window and the view into which it has been dropped, and (e) the user name. Once the link has been selected, it is added to the database and is accessible to the main user interface.

### A Method for Communicating Information to Servers that Process and Store the Info

Once a hyperlink is dropped into a window, information is passed by the window to the backend servers. This information includes the address of the hyperlink, as defined hereinabove. In addition, the information about the window and the view containing that window is also sent to the server. This information is then used by scripts to generate the front page in HTML.

### A Mechanism for Checking for Change in the Content or the Format of the Selected Sources of Information

One feature of the current invention is that refreshed content is retrieved from the selected sources of information as they are updated. The sources of information, or web-sites, selected by users are cached locally. The web pages stored locally are categorized according to the number of times they are requested. High request sites may be retrieved once every few hours.

### A Mechanism for Checking for Change in the Content or the Format of the Selected Sources of Information

Once a page has been requested by a user, it is retrieved on a regular basis. There are two checks performed to find out a change in the information in the page. The first involves a change in the content of the page and the second a change in the format in which the content is presented.

Change in the Content of a Page

Every time a page is retrieved, a copy is kept locally on specially equipped servers. Once a page is automatically retrieved, the content from the newly retrieved version of the page is compared to the content from a previous version of the page. If there is a change in the content, then the updated content is retrieved.

Change in the Format of Content

The formatting of the content in a page is stored in terms of a complete addressing scheme for the page, which specifies the breakdown of the page into its sub-sections. Once there is a change in the formatting of the page, then the relations of different sub-sections of the page to their parent sections change. A mechanism may be implemented that keeps track of the number of differences between the format of a previously stored version of the page and the newly retrieved version. An alert may then be sent to a user if the number of differences is greater than a configurable number.

A customizable information retrieval engine has thus been described that allows users to aggregate content of their choice from any web-site in existence. The content may include, but is not restricted to: text (i.e. news headlines, hyperlinks in web-pages), secure account information (i.e. email, bank accounts, utilities, and stock portfolios), services (i.e. maps, directions, weather, web searches), financial transactions (i.e. online shopping, buying, selling, trading, auctions, barters, comparisons) and other dynamic tasks that involve interaction of the users with other web-based (client and server side) services. The aggregated content may be displayed in a customized web-based habitat, which is amenable to presentation and content customization through an intuitive interface.

Preferred Embodiments

FIG. 1A illustrates a method 160 for transferring information from a network to a thin client device. In one embodiment, the present method 160 may be carried out in the context of the foregoing exemplary environment. It should be noted, however, that the principles disclosed herein may be applied in any desired manner.

Initially, in operation 162, a user is permitted to select components of a form in a hypertext markup language (HTML) format. The component of the form may take any form including, but not limited to an input field, an actuator icon, a menu, and/or any other input or output mechanism.

Such components of the form are then sent to a thin client device. Note operation 164. The thin client device may take any form including, but not limited to a wireless personal digital assistant (PDA), a pager, a web phone, a cell phone (or any other voice communication device), or any other type of computer with limited capacity due to its mobile or compact nature. In response thereto, the components of the form are displayed on the thin client device in operation 166.

As an option, the thin client device may operate in an input mode based on the receipt of the components of the form. In such input mode, a user of the thin client device may be prompted to input data. Further, such data may be used to retrieve content for display on thin client devices. Additional information regarding the above process will now be set forth in the following figures.

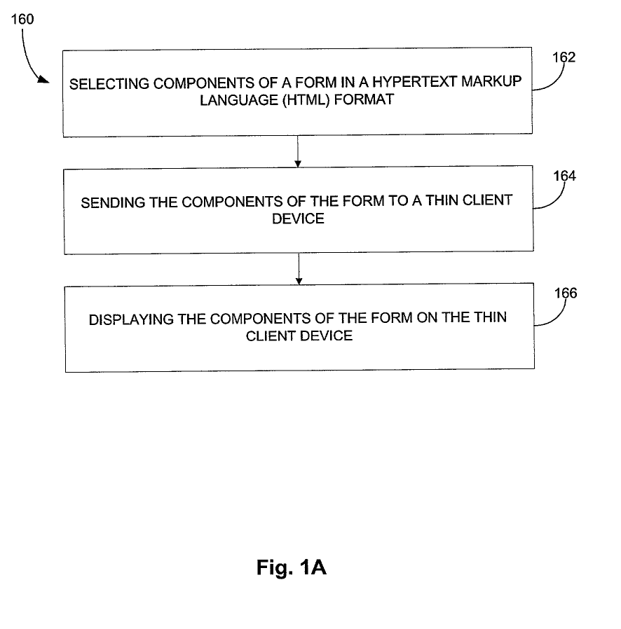

FIG. 2 illustrates the manner in which the data is transformed into different formats 200 while be transferred from a network environment to a thin client device. As shown, the data begins in an HTML tabular format 202 after which it is converted into an XML format 204, and then optionally to other formats 206 selected from the group consisting of WML, HTML, Voice XML, plain text, etc.

FIG. 2A illustrates an exemplary display of a form information screen in accordance with an embodiment of the present invention. Specifically, FIG. 2A illustrates a weather form 240. A user may input a zip code number in a field 242 provided by the form. The user may then submit the form using an actuation icon 244.

FIG. 2B illustrates an exemplary display of a form information screen 250 transformed to XML in accordance with an embodiment of the present invention. Such transformation is done in response to the selection of the various components of the form of FIG. 2A. This may be accomplished using a workstation (see FIG. 1) that is networked to a server on the network. In use, a user may indicate the specific component of the form that is selected, and further associate an input mode therewith. Note user inputs 251.

As shown in FIG. 2B, a zip code field 252 may be assigned a numeric input mode indicator based on the user input 251. In the alternative, the zip code field 252 may be assigned a voice input mode indicator. Such XML input mode indicators may prompt the thin client device to accept input from the user. As such, a user can say “O,” 1, 2, 3, etc., and the “O” may be translated into the number zero, and so on. Once filled in, the form may be submitted using an actuation icon 254.

After the transformation is complete, the XML form of FIG. 2B may be stored for the purpose of being sent to a thin client device to collect information from a user. Additional information regarding such process will now be set forth.

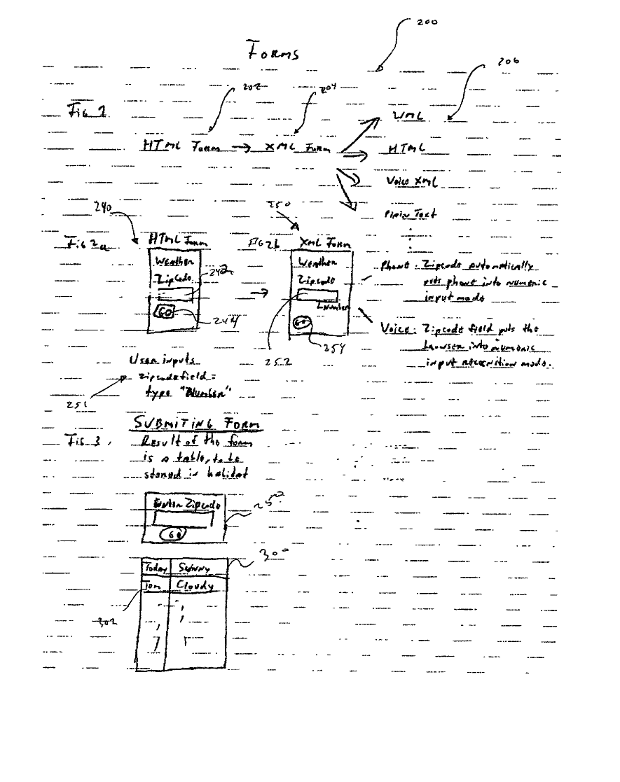

FIG. 3 illustrates an exemplary table 300 that is generated in response to user inputs from the form information screen 250 of FIG. 2B. Such table may include a plurality of rows or columns of cells including parameters 302 in tabular format. For example, such parameters may include a date, weather condition, etc. With information in such format, it can be conveniently transmitted to and displayed on the thin client device. One exemplary method of transmitting the information using transcoding is disclosed in a co-pending application filed concurrently herewith under the title “SYSTEM, METHOD AND COMPUTER PROGRAM PRODUCT FOR TRANSCODING TABULAR CONTENT FOR DISPLAY ON THIN CLIENT DEVICES BY WAY OF CONTENT ADDRESSING” under attorney docket number CLIC1P009, and which is incorporated herein by reference in its entirety.

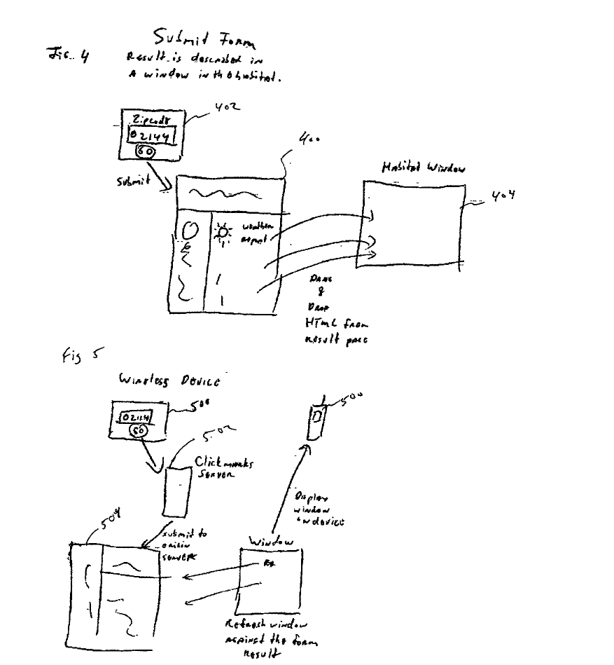

FIG. 4 is an illustration of an HTML page 400 including weather information in accordance with another preferred embodiment. This page is generated in response to a user entering a zip code using an interface 402 on a thin client device. Once the HTML page 400 is displayed, a user may drag and drop portions of the HTML form to a result page 404, or a “habitat.” This may be accomplished by simply displaying both the HTML page 400 and the result page 404 simultaneously for allowing a user to drag and drop components using a mouse or the like. It should be noted that the drag and dropped portions of the HTML form may include cells with information that the user desires to be displayed on the thin client device during use. This allows customization of the content to be displayed on the thin client device.

An Internet habitat (“a habitat”) allows a user to create an information portal whose source and content is completely customizable. Information on the web exists in the form of hyperlinks that appear in different web sites. A news site for example may contain headlines that are hyperlinks to their detailed exposition. In typical portals, a user chooses from a pre-determined set of headlines collected from a pre-determined set of web-sites. A user has no control over either the web-sites the user gets the content from or the headlines that are taken from those web-sites. A habitat allows a user to completely configure both the source and content that user personally desires in an information portal.

In the present case, the habitat allows a user to create a customized portal based on an intuitive drag and drop capability. A user simply selects the sources or headlines of choice and drags and drops them into windows and views of choice. This drag and drop feature also makes customization easy for the user, allowing quick compilation and management of preferred content.

FIG. 5 illustrates a flow diagram showing an exemplary application of the principles of the present invention during use. As shown, a thin client device 500 is provided with a display in accordance with a preferred embodiment. Such display may be configured in accordance with the principles set forth in FIGS. 2A and 2B. Upon the receipt of input from the thin client device 500, a server 502 submits the information to the uniform resource locator (URL) to receive the desired information in the form of an HTML page 504.

The information on the HTML page 504 may be simply transmitted to the thin client device 500 in tabular format in accordance with the principles discussed in FIG. 3. In the alternative, only certain components of the page may be transmitted to the thin client device 500 based on a drag and drop selection made in accordance with the principles discussed in FIG. 4.

It should be noted that forms embedded within a table may be automatically transformed, so that the user is able to interact with the form. More information will now be set forth regarding how to display arbitrary forms on any thin client device, and allow the user to interact with the form, submit data, and receive a meaningful response.

In order to display an arbitrary HTML form correctly, the form may be parsed into an XML representation first. This XML representation may then be rendered onto the device. There are three (3) different kinds of forms that may be supported Note Table 1.

TABLE 1
DB Form - This form stores the result in the database as a table. Thus,
to display the results of the form to the user, this table may be displayed
on the device after the form is submitted and the database has been
updated.
Window Form - This form stores the result in the database as dynamic
content in a window. This may include images, URLs, tables, etc. that
have been dragged and dropped from the form result page into the
window. Upon form submission, the content in the designated window
is refreshed against the form result page. The window is then displayed
to the user.
Direct Form - The results of this type of form are returned unmodified
to the server as HTML, HDML, WML, VoiceXML or random XML. If
the results are returned as HTML, depending on the device, the server may
transcode it to the format supported by the device. If the results are
returned as a recognized display format supported by the device, the
results may be passed through to the device. Otherwise, an error may be
reported to the user.

In order to display the form, the user may specify the form type when the form is dragged into the habitat. In addition, the user may add semantic information about this form. For example, an arbitrary text input field may be handled better in the voice channel if the type of data entered into this field is known (e.g. “zip code”). The form property dialog may be available when the user drags a form into the habitat, or when the user right-clicks on the form in the edit control.

As such, the form may be first processed by a server, and transcoded for display on the device. After accepting user input, the form is submitted back to the server, and not necessarily an original server. At this point, the server sends the data entered by the user on the device, plus any additional data stored in the database, to the original server, ain effect submitting the form on behalf of the user. When the result of the form submission comes back from the original server, it is processed as explained hereinabove.

The results are copied into the database, as per the original instructions of the user, from where they can be displayed to the user. The results in this case are limited to a table. The results may be dynamically added to a particular window in the habitat. Upon form submission, this window is displayed to the device, thus displaying the results of the form submission. The results are transcoded on the fly for display to the device. This is undesirable as the entire resulting web page has to be transcoded since the server may have no information about which parts of the result page should be displayed to the device. In one embodiment, this mechanism may be used as a last resort only.

### Example

An example of the foregoing concepts will now be set forth. It should be noted that such example is not to be construed as exhaustive or limiting, and may be applied in any desired manner and in any desired context.

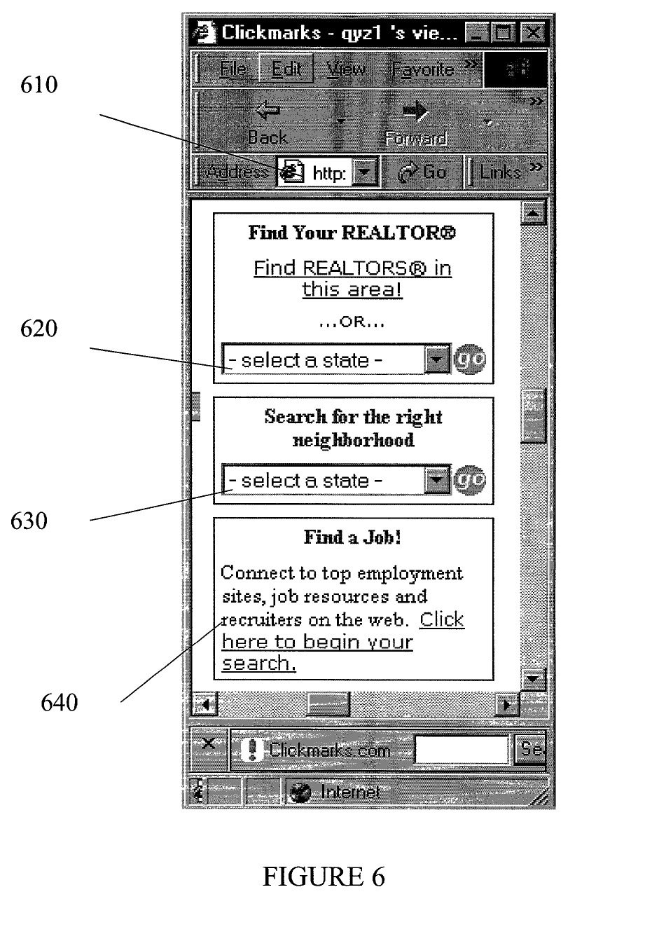

FIG. 6 illustrates an exemplary submitting form in accordance with an embodiment of the present invention. This form represents a real estate finder, located at an IP address 610 on a network. A user is prompted to enter a state 620 in order to find a realtor or a neighborhood 630. There is also a job search tool 640 located on this page. This information may be transferred to a habitat in accordance with the principles set forth during the description of FIGS. 2A and 2B, where it becomes suitable for wireless transfer.

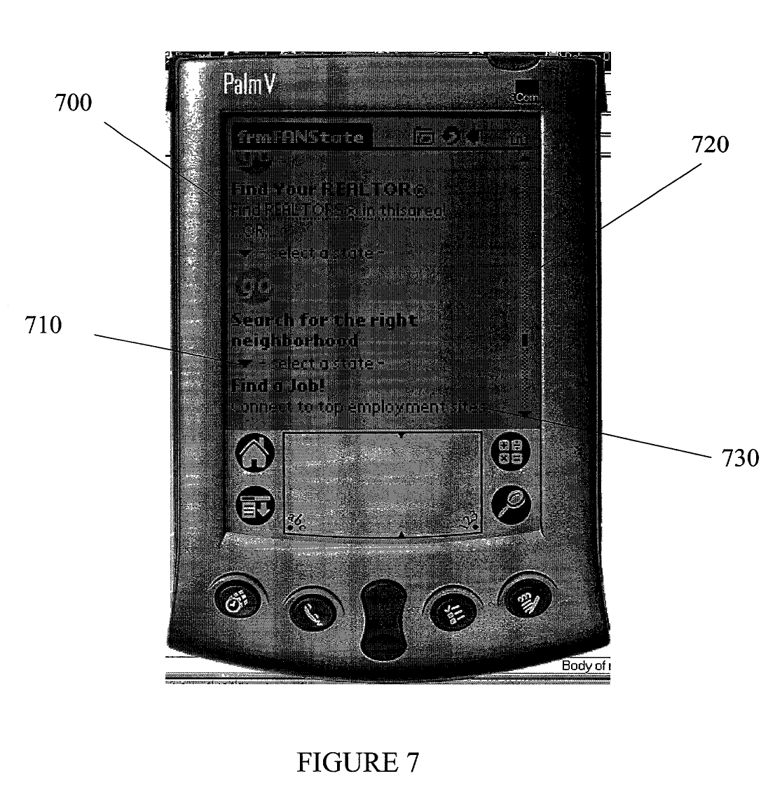

FIG. 7 illustrates an exemplary thin client device display in accordance with an embodiment of the present invention. Here, it is seen that the thin client device is able to display prompts for inputting a state 700, 710, as well as displaying a job search tool 730. Further, a user can scroll 720 to see the remainder of the page.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for transferring information from a network to a thin client device, comprising the steps of:
(a) selecting components of a form in a hypertext markup language (HTML) format;
(b) sending the components of the form to a thin client device; and
(c) displaying the components of the form on the thin client device.

2. The method as recited in claim 1, wherein the component of the form include an input field, an actuator icon, and a menu.

3. The method as recited in claim 1, wherein the thin client device operates in an input mode based on the receipt of the components of the form.

4. The method as recited in claim 3, wherein the input mode prompts a user of the thin client device to input data.

5. The method as recited in claim 4, wherein the data is used to retrieve content for display on thin client devices.

6. The method as recited in claim 1, wherein the thin client device includes a wireless device.

7. A computer program product for transferring information from a network to a thin client device, comprising:
(a) computer code for selecting components of a form in a hypertext markup language (HTML) format;
(b) computer code for sending the components of the form to a thin client device; and
(c) computer code for displaying the components of the form on the thin client device.

8. The computer program product as recited in claim 7, wherein the component of the form include an input field, an actuator icon, and a menu.

9. The computer program product as recited in claim 7, wherein the thin client device operates in an input mode based on the receipt of the components of the form.

10. The computer program product as recited in claim 9, wherein the input mode prompts a user of the thin client device to input data.

11. The computer program product as recited in claim 10, wherein the data is used to retrieve content for display on thin client devices.

12. The computer program product as recited in claim 7, wherein the thin client device includes a wireless device.

13. A system for transferring information from a network to a thin client device, comprising:
(a) logic for selecting components of a form in a hypertext markup language (HTML) format;
(b) logic for sending the components of the form to a thin client device; and
(c) logic for displaying the components of the form on the thin client device.

14. The system as recited in claim 13, wherein the component of the form include an input field, an actuator icon, and a menu.

15. The system as recited in claim 13, wherein the thin client device operates in an input mode based on the receipt of the components of the form.

16. The system as recited in claim 15, wherein the input mode prompts a user of the thin client device to input data.

17. The system as recited in claim 16, wherein the data is used to retrieve content for display on thin client devices.

18. The system as recited in claim 13, wherein the thin client device includes a wireless device.
